(19) United States
(12) Patent Application Publication
(10) Pub. No.: US 2016/0123531 A1
(43) Pub. Date: May 5, 2016

(54) BOIL-OFF GAS TEMPORARY STORAGE SYSTEM

(71) Applicant: KOREA ADVANCED INSTUTUTE OF SCIENCE AND TECHNOLOGY, Daejeon (CN)

(72) Inventor: Dae Jun Chang, Daejeon (KR)

(73) Assignee: Korea Advanced Institute of Science and Technology, Daejeon (KR)

(21) Appl. No.: 14/889,392

(22) PCT Filed: May 2, 2014
(86) PCT No.: PCT/KR2014/003942

§ 371 Date: Nov. 5, 2015

(30) Foreign Application Priority Data
May 6, 2013 (KR) 10-2013-0050640

(51) Int. Cl. F17C 1/00; F17C 9/04

(52) U.S. Cl. CPC F17C 1/002; F17C 9/04; F17C 2223/0161; F17C 2223/0123; F17C 2225/0123; F17C 2225/0161; F17C 2227/0135; F17C 2223/035; F17C 2260/02; F17C 2270/0105; F17C 2221/033; F17C 2265/037

(57) ABSTRACT

Provided is a boil-off gas temporary storage system and, more particularly, is a boil-off gas temporary storage system which compresses boil-off gas at high pressure, temporarily stores the compressed boil-off gas in a boil-off gas absorbing tank, supplies the stored boil-off gas to a high-pressure gas transmission part and a high-pressure liquefied natural gas transmission part to recycle the boil-off gas, controls the pressure of a low-pressure liquefied natural gas cargo tank and a fuel liquefied natural gas tank of a ship to be filled with gas, and removes the necessity of a complicated and high-priced re-liquefaction device, in a method for removing the boil-off gas to depressurize the fuel liquefied natural gas tank of a ship to be filled with gas in the relatively high-pressure state before supplying the liquefied natural gas to a ship to be filled with gas.

### TECHNICAL FIELD

The present invention relates to a boil-off gas temporary storage system, and more specifically, to a boil-off gas temporary storage system which compresses boil-off gas at high pressure, temporarily stores the compressed boil-off gas in a boil-off gas absorbing tank, and supplies the stored boil-off gas to a high-pressure gas transmission part and a high-pressure liquefied natural gas transmission part, in a method for removing the boil-off gas to depressurize the fuel liquefied natural gas tank of a ship to be filled with gas in the relatively high-pressure state before supplying the liquefied natural gas to a ship to be filled with gas.

### BACKGROUND ART

Shipping businesses that are having a great hard time because of low profitability due to high oil prices have preferred more economical and eco-friendly ships.

In particular, with the use trend of green energy for preventing global warming, power sources used to obtain a propulsion force of ships are tending to replace diesel oil with liquefied natural gas and studies on ships using the liquefied natural gas as power sources have been actively conducted.

A process of depressurizing a fuel liquefied natural gas tank of a ship to be filled with gas in a relatively high-pressure state is required before supplying low-temperature liquefied natural gas to ships using the liquefied natural gas as the power source.

The above depressurizing process is performed by a method for removing boil-off gas of the fuel liquefied natural gas tank of a ship to be filled with gas. Typically, a method for re-liquefying or combusting the boil-off gas has been used to remove the boil-off gas generated when a liquefied natural gas cargo tank is filled with the liquefied natural gas.

FIG. 1 is a diagram schematically illustrating the existing system for re-liquefying boil-off gas to remove the boil-off gas.

As illustrated in FIG. 1, the system for re-liquefying boil-off gas to remove the boil-off gas compresses a low-pressure boil-off gas generated from a low-pressure liquefied natural gas cargo tank and a fuel liquefied natural gas tank of a ship to be filled with gas by a compressor, converts the low-pressure boil-off gas into high-pressure boil-off gas, supplies the high-pressure boil-off gas to a high-pressure gas transmission part or re-liquefies the high-pressure boil-off gas with a re-liquefaction system, and again supplies the re-liquefied gas to the low-pressure liquefied natural gas cargo tank.

However, the re-liquefaction system for removing the boil-off gas as described above is expensive and requires complicated processes for treating the boil-off gas and much time to treat the boil-off gas.

Further, the method for removing boil-off gas by combustion may not avoid a loss of the boil-off gas and cause a generation of greenhouse gases due to the combustion. Therefore, solutions to the problems are required.

### DISCLOSURE

### Technical Problem

An object of the present invention is to provide a boil-off gas temporary storage system capable of controlling a pressure of a low-pressure liquefied natural gas cargo tank and a fuel liquefied natural gas tank of a ship to be filled with gas by removing the boil-off gas of the low-pressure liquefied natural gas cargo tank and the fuel liquefied natural gas tank of a ship to be filled with gas.

Another object of the present invention is to provide a boil-off gas temporary storage system capable of recycling the boil-off gas discarded by combustion, etc., by temporarily storing the boil-off in a boil-off gas absorbing tank and then supplying the boil-off gas to a high-pressure gas transmission part and a high-pressure liquefied natural gas transmission part.

Still another object of the present invention is to provide a boil-off gas temporary storage system which does not require a complicated and expensive re-liquefaction system for re-liquefying the boil-off gas to treat the boil-off gas.

### Technical Solution

In one general aspect, a boil-off gas temporary storage system including a fuel tank pressure control valve controlling a pressure of a fuel liquefied natural gas tank of a ship to be filled with gas to discharge low-pressure boil-off gas using liquefied natural gas as fuel, a cargo tank pressure control valve controlling a pressure of the low-pressure liquefied natural gas cargo tank storing or supplying low-pressure liquefied natural gas to discharge the low-pressure boil-off gas, and a compressor compressing the low-pressure boil-off gas discharged from the fuel tank pressure control valve and the cargo tank pressure control valve to be converted into high-pressure boil-off gas includes: a boil-off gas absorbing tank absorbing the high-pressure boil-off gas generated by the compressor and storing the high-pressure boil-off gas and the liquefied natural gas while being vapor-liquid separated from each other; an absorbing tank pressure control valve controlling the pressure of the boil-off gas absorbing tank to supply the high-pressure boil-off gas to a high-pressure gas transmission part; and a first liquefied natural gas pump re-introducing and re-circulating a part of the liquefied natural gas discharged from the boil-off gas absorbing tank 40 into the boil-off gas absorbing tank.

The boil-off gas temporary storage system may further include: a liquefied natural gas injector injecting the re-introduced liquefied natural gas into the boil-off gas absorbing tank and formed at an upper portion of the boil-off gas absorbing tank.

The first liquefied natural gas pump may supply the liquefied natural gas of the boil-off gas absorbing tank to a high-pressure liquefied natural gas transmission part.

The boil-off gas temporary storage system may further include: a third liquefied natural gas pump introducing and re-circulating a part of the liquefied natural gas of the low-pressure liquefied natural gas cargo tank into the boil-off gas absorbing tank.

The boil-off gas temporary storage system may further include: a compressor bypass path bypassing the boil-off gas generated from the fuel liquefied natural gas tank of a ship to be filled with gas to prevent the boil-off gas from passing through the compressor.

### Advantageous Effects

According to the exemplary embodiments of the present invention, the boil-off gas temporary storage system may remove the boil-off gas of the low-pressure liquefied natural gas cargo tank and the fuel liquefied natural gas tank of a ship to be filled with gas to control the pressure of the low-pressure liquefied natural gas cargo tank and the fuel liquefied natural gas tank of a ship to be filled with gas.

In particular, according to the exemplary embodiments of the present invention, the boil-off gas temporary storage system may recycle the boil-off gas discarded by the combustion, etc., by temporarily storing the boil-off gas in a boil-off gas absorbing tank and then supplying the boil-off gas to the high-pressure gas transmission part and the high-pressure liquefied natural gas transmission part.

Further, according to the exemplary embodiments of the present invention, the boil-off gas temporary storage system does not require the pressure device for increasing the pressure of fuel to be used as fuel by storing the boil-off gas in the boil-off gas absorbing tank at a high pressure and then supplying the boil-off gas to the high-pressure gas transmission part and the high-pressure liquefied natural gas transmission part.

Further, according to the exemplary embodiments of the present invention, the boil-off gas temporary storage system may not require the complicated and expensive re-liquefaction system for re-liquefying the boil-off gas.

Further, the boil-off gas temporary storage system according to the exemplary embodiments of the present invention absorbs the boil-gas into the liquefied natural gas and stores it, such that the volume of the boil-off gas storage tank may be much more reduced compared to a gas storing method.

### DESCRIPTION OF DRAWINGS

FIG. 1 is a diagram schematically illustrating a boil-off gas re-liquefaction system according to the related art.

FIG. 2 is a diagram schematically illustrating a boil-off gas temporary storage system according to an exemplary embodiment of the present invention.

FIG. 3 is a diagram schematically illustrating an absorption promotion device for promoting absorption of the boil-off gas into the boil-off gas temporary storage system according to the exemplary embodiment of the present invention.

FIG. 4 is a diagram schematically illustrating another absorption promotion device for promoting absorption of the boil-off gas into the boil-off gas temporary storage system according to the exemplary embodiment of the present invention.

### BEST MODE

Hereinafter, a boil-off gas temporary storage system according to an exemplary embodiment of the present invention having the above-mentioned characteristics will be described in more detail with reference to the accompanying drawings.

Terms and words used in the present specification and claims are not to be construed as a general or dictionary meaning, but are to be construed as meaning and concepts meeting the technical ideas of the present invention based on a principle that the present inventors may appropriately define the concepts of terms in order to describe their inventions in the best mode.

Therefore, configurations described in exemplary embodiments and the accompanying drawings of the present specification do not represent all of the technical spirits of the present disclosure, but are merely most preferable embodiments. Therefore, the present disclosure should be construed as including all the changes, equivalents, and substitutions included in the spirit and scope of the present disclosure at the time of filing this application.

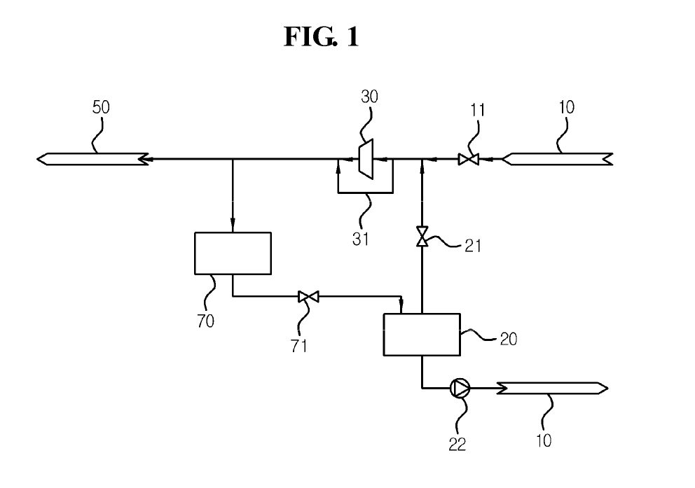

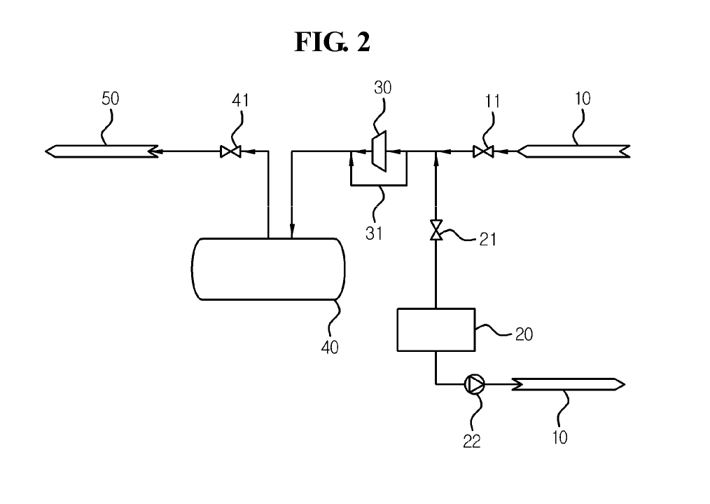

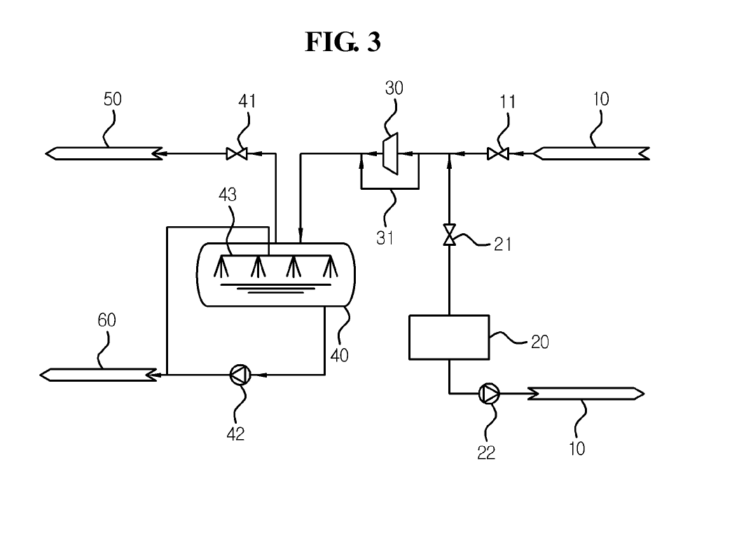

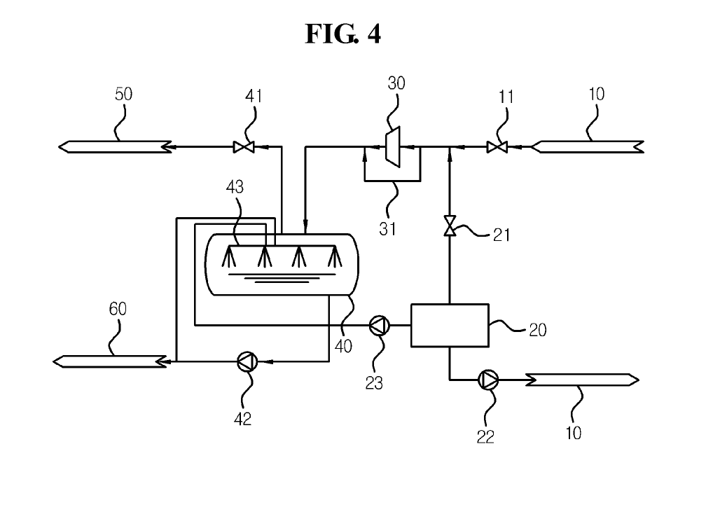

FIG. 1 is a diagram schematically illustrating a boil-off gas re-liquefaction system according to the related art, FIG. 2 is a diagram schematically illustrating a boil-off gas temporary storage system according to an exemplary embodiment of the present invention, FIG. 3 is a diagram schematically illustrating an absorption promotion device for promoting absorption of the boil-off gas into the boil-off gas temporary storage system according to the exemplary embodiment of the present invention, and FIG. 4 is a diagram schematically illustrating another absorption promotion device for promoting absorption of the boil-off gas into the boil-off gas temporary storage system according to the exemplary embodiment of the present invention.

A fuel liquefied natural gas tank of a ship to be filled with gas 10 needs to be depressurized before being filled with gas from a low-pressure liquefied natural gas cargo tank 20. The depressurizing process is performed by a method for removing boil-off gas from the fuel liquefied natural gas tank of a ship to be filled with gas 10.

As illustrated in FIGS. 2 to 4, to remove the boil-off gas generated from the fuel liquefied natural gas tank of a ship to be filled with gas 10, the boil-off gas is discharged to a boil-off gas absorbing tank 40 by a fuel tank pressure control valve 11 controlling a pressure of the fuel liquefied natural gas tank of a ship to be filled with gas 10 and is absorbed into the boil-off gas absorbing tank 40 for storage.

The boil-off gas of the low-pressure liquefied natural gas cargo tank 20 to fill liquefied natural gas in a ship to be filled with gas is also absorbed into the boil-off gas absorbing tank 40 for storage by a cargo tank pressure control valve 21 controlling the pressure of the low-pressure liquefied natural gas cargo tank 20.

Since the pressure of the boil-off gas absorbing tank 40 rises as the boil-off gas absorbing tank 40 absorbs the boil-off gas, to continuously absorb the boil-off gas into the boil-off gas absorbing tank 40, low-pressure boil-off gas needs to be changed to high-pressure boil-off gas.

As illustrated in FIGS. 2 to 4, the compressor 30 is installed to change the low-pressure boil-off gas to the high-pressure boil-off gas, which is then absorbed into the boil-off gas absorbing tank 40.

However, unlike the case in which the low-pressure boil-off gas is changed to the high-pressure boil-off gas by passing through the compressor 30, when the pressure of the boil-off gas of the fuel liquefied natural gas tank of a ship to be filled with gas 10 is sufficiently high, the boil-off gas does not pass through the compressor 30 but bypasses the compressor 30 to be stored in the boil-off gas absorbing tank 40.

By the method, the boil-off gas absorbing tank 40 continuously absorbs the high-pressure boil-off gas to be stored and when the boil-off gas absorbing tank 40 may no longer absorb the high-pressure boil-off gas, the boil-off gas needs to be discharged.

In other words, when the pressure of the boil-off gas absorbing tank 40 excessively rises due to the continuous absorption of the high-pressure boil-off gas, the high-pressure boil-off gas is supplied to a high-pressure liquefied natural gas transmission part 50 to reduce the temperature and the pressure of the boil-off gas absorbing tank 40.

Further, an absorbing tank pressure control valve 41 discharging the high-pressure boil-off gas by controlling the pressure of the boil-off gas absorbing tank 40 is formed to supply the high-pressure boil-off gas to the high-pressure gas transmission part 50.

The boil-off gas temporary storage system as described above may control the pressure of the fuel liquefied natural gas tank of a ship to be filled with gas 10 and the low-pressure liquefied natural gas cargo tank 20.

Further, the discarded boil-off gas is supplied to the high-pressure gas transmission part 50 to be recycled, which prevents the discarded boil-off gas from being lost and has positive effects on environment.

As illustrated in FIG. 3 or 4, to promote the absorption of the boil-off gas, the boil-off gas temporary storage system according to the exemplary embodiment of the present invention is provided with a first liquefied natural gas pump 42 that re-introduces a part of the liquefied natural gas discharged from the boil-off gas absorbing tank 40 into the boil-off gas absorbing tank 40 again to be re-circulated.

The liquefied natural gas re-circulated by the first liquefied natural gas pump 42 is re-introduced into the boil-off gas absorbing tank 40 through a liquefied natural gas injector 43 formed in the boil-off gas absorbing tank 40, thereby promoting the absorption of the boil-off gas.

In other words, the boil-off gas absorbing tank 40 stores the high-pressure liquefied natural gas generated by compressing the boil-off gas with the compressor 30 or generated by absorbing the boil-off gas of the fuel liquefied natural gas tank of a ship to be filled with gas 10 into boil-off gas absorbing tank 40 while being vapor-liquid separated from the high-pressure boil-off gas.

Further, as illustrated in FIG. 4, the low-pressure liquefied natural gas tank 20 includes a second liquefied natural gas pump 22 serving to supply the stored liquefied natural gas to the fuel liquefied natural gas tank of a ship to be filled with gas 10 and a third liquefied natural gas pump 23 re-circulating the stored liquefied natural gas to the boil-off gas absorbing tank 40 to promote the absorption of the boil-off gas.

In other words, the boil-off gas temporary storage system introduces the relatively higher-pressure boil-off gas into the boil-off gas absorbing tank 40 in the state in which the relatively lower-pressure liquefied natural gas is stored in the boil-off gas absorbing tank 40, in which the introduced boil-off gas reaches a vapor-liquid equilibrium state by being absorbed into the liquefied natural gas stored in the boil-off gas absorbing tank 40.

In this case, the liquefied natural gas introduced into the boil-off gas absorbing tank 40 through the first liquefied natural gas pump 42 or the third liquefied natural gas pump 23 promotes the absorption of the boil-off gas and thus reaches the vapor-liquid equilibrium state in a rapid time.

Further, the boil-off gas temporary storage system absorbs the boil-off gas into the liquefied natural gas and stores it in the boil-off gas absorbing tank 40, such that the volume of the boil-off gas absorbing tank 40 may be much more reduced compared to the gas storing method.

As illustrated in FIG. 3 or 4, the first liquefied natural gas pump 42 may re-circulate the liquefied natural gas to promote the absorption of the boil-off gas and supply the high-pressure liquefied natural gas even to the high-pressure liquefied natural gas transmission part 60.

In other words, the boil-off gas temporary storage system according to the exemplary embodiment of the present invention may supply the high-pressure boil-off gas to a high-pressure gas transmission part 50 and supply the high-pressure liquefied natural gas even to a high-pressure liquefied natural gas transmission part 60 in the process of treating boil-off gas.

The boil-off gas temporary storage system according to the exemplary embodiment of the present invention supplies the high-pressure boil-off gas and the high-pressure liquefied natural gas to the high-pressure gas transmission part 50 and the high-pressure liquefied natural gas transmission part 60, thereby recycling the boil-off gas and the liquefied natural gas discarded by the combustion, etc.

Further, the boil-off gas temporary storage system according to the exemplary embodiment of the present invention supplies the high-pressure boil-off gas and the high-pressure liquefied natural gas to the high-pressure gas transmission part 50 and the high-pressure liquefied natural gas transmission part 60, thereby removing the necessity of the installation of the pressure device that increases the pressure to use the high-pressure boil-off gas and the high-pressure liquefied natural gas as fuel.

Further, the boil-off gas temporary storage system according to the exemplary embodiment of the present invention does not require a re-liquefaction device 70 for re-liquefying the boil-off gas and performs a boil-off gas removing process for reducing the complicated process and a time required to treat the boil-off gas to increase the efficiency of the depressurizing process of the fuel liquefied natural gas tank of a ship to be filled with gas 10 and remove the necessity of installation of the expensive re-liquefaction device 70, thereby reducing the overall costs of the depressurizing process.

### DETAILED DESCRIPTION OF MAIN ELEMENTS

10: Liquefied natural gas tank of ship to be filled with gas
11: Fuel tank pressure control valve
20: Low-pressure liquefied natural gas cargo tank
21: Cargo tank pressure control valve
22: Second liquefied natural gas pump
23: Third liquefied natural gas pump
30: Compressor
31: Compressor bypass path
40: Boil-off gas absorbing tank
41: Absorbing tank pressure control valve
42: First liquefied natural gas pump
43: Liquefied natural gas injector
50: High-pressure gas transmission part
60: High-pressure liquefied natural gas transmission part
70: Re-liquefaction device
71: Re-liquefaction discharge valve

1. A boil-off gas temporary storage system including a fuel tank pressure control valve 11 controlling a pressure of a fuel liquefied natural gas tank of a ship to be filled with gas 10 to discharge low-pressure boil-off gas, a cargo tank pressure control valve 21 controlling a pressure of the low-pressure liquefied natural gas cargo tank 20 storing or supplying low-pressure liquefied natural gas to discharge the low-pressure boil-off gas, and a compressor 30 compressing the low-pressure boil-off gas discharged from the fuel tank pressure control valve 11 and the cargo tank pressure control valve 21 to be converted into high-pressure boil-off gas, the boil-off gas temporary storage system comprising:
a boil-off gas absorbing tank 40 absorbing the high-pressure boil-off gas generated by the compressor 30 and storing the high-pressure boil-off gas and liquefied natural gas while being vapor-liquid separated from each other;
an absorbing tank pressure control valve 41 controlling a pressure of the boil-off gas absorbing tank 40 to supply the high-pressure boil-off gas to a high-pressure gas transmission part 50; and
a first liquefied natural gas pump 42 re-introducing and re-circulating a part of the liquefied natural gas discharged from the boil-off gas absorbing tank 40 into the boil-off gas absorbing tank 40.

2. The boil-off gas temporary storage system of claim 1, further comprising:
a liquefied natural gas injector 43 injecting the re-introduced liquefied natural gas into the boil-off gas absorbing tank 40 and formed at an upper portion of the boil-off gas absorbing tank 40.

3. The boil-off gas temporary storage system of claim 1, wherein the first liquefied natural gas pump 42 supplies the liquefied natural gas of the boil-off gas absorbing tank 40 to a high-pressure liquefied natural gas transmission part 60.

4. The boil-off gas temporary storage system of claim 1, further comprising:
a third liquefied natural gas pump 23 introducing and re-circulating a part of the liquefied natural gas of the low-pressure liquefied natural gas cargo tank 20 into the boil-off gas absorbing tank 40.

5. The boil-off gas temporary storage system of claim 1, further comprising:
a compressor bypass path 31 bypassing the boil-off gas generated from the fuel liquefied natural gas tank of a ship to be filled with gas 10 to prevent the boil-off gas from passing through the compressor 30.
